(19) United States
(12) Patent Application Publication
(10) Pub. No.: US 2025/0021030 A1
(43) Pub. Date: Jan. 16, 2025

(54) IRON ION-RELEASING SUBSTANCE

(71) Applicant: SHARP KABUSHIKI KAISHA, Sakai City (JP)

(72) Inventor: Yohei OTSUKA, Sakai City (JP)

(21) Appl. No.: 18/760,064

(22) Filed: Jul. 1, 2024

(30) Foreign Application Priority Data
Jul. 11, 2023 (JP) 2023-113375

(51) Int. Cl. G03G 9/113

(52) U.S. Cl. CPC G03G 9/1139

(57) ABSTRACT

An iron ion-releasing substance comprises a developer including a carrier core containing metal iron, and a toner attached to part of a surface of the carrier core; and a carbon material covering the developer, wherein the iron ion-releasing substance is a molded body obtained by pressing and molding the developer and the carbon material.

### CROSS-REFERENCE TO RELATED APPLICATION

The present application claims priority from Japanese Application JP2023-113375, the content of which is hereby incorporated by reference into this application.

### BACKGROUND

### 1. Field

The present disclosure relates to an iron ion-releasing substance.

### 2. DESCRIPTION OF THE RELATED ART

Releasing substances have been normally disclosed.

For example, an iron ion-releasing substance obtained by mixing iron powder and coke breeze (carbon), followed by sintering has been disclosed as a known technology. In the iron ion-releasing substance, electrons are transferred from iron to carbon to form divalent iron ions, and the iron ions are released in water and bound to phosphorus and nitric acid that are causes of eutrophication, to achieve water purification.

### SUMMARY

However, the iron ion-releasing substance according to the known technology has a problem in which the iron ion-releasing substance does not achieve water purification without adding a large amount of the iron ion-releasing substance to water, and cannot release a stable amount of iron ions for an extended period of time. This is because the iron-releasing substance uses iron powder, the iron powder has a large particle diameter and a small contact area of iron with carbon, and cannot be sufficiently dispersed.

In view of the problem, the present disclosure provides an iron ion-releasing substance that can sufficiently disperse iron ions in water and release a stable amount of iron ions for an extended period of time.

An iron ion-releasing substance according to an aspect of the present disclosure includes a developer including a carrier core containing metal iron and a toner attached to part of a surface of the carrier core, and a carbon material covering the developer, and is a molded body obtained by pressing and molding the developer and the carbon material.

According to the present disclosure, an iron ion-releasing substance that can sufficiently disperse iron ions in water and release a stable amount of iron ions for an extended period of time can be provided as described above.

### BRIEF DESCRIPTION OF THE DRAWINGS

FIG. 1 is a cross-sectional view of an iron ion-releasing substance according to the present disclosure.

FIG. 2 is a cross-sectional view of a developer in the iron ion-releasing substance according to the present disclosure.

FIG. 3 is a cross-sectional view of a carrier in the iron ion-releasing substance according to the present disclosure.

FIG. 4 is a view of the iron ion-releasing substance according to the present disclosure that is formed into a pellet shape.

### DESCRIPTION OF EMBODIMENTS

Preferable embodiments of the present disclosure will be described in detail hereinafter with reference to the drawings. The present embodiment described below does not unreasonably limit what is defined in the appended claims. All of elements of configuration described in the embodiment are not necessarily essential for the solution of the present disclosure.

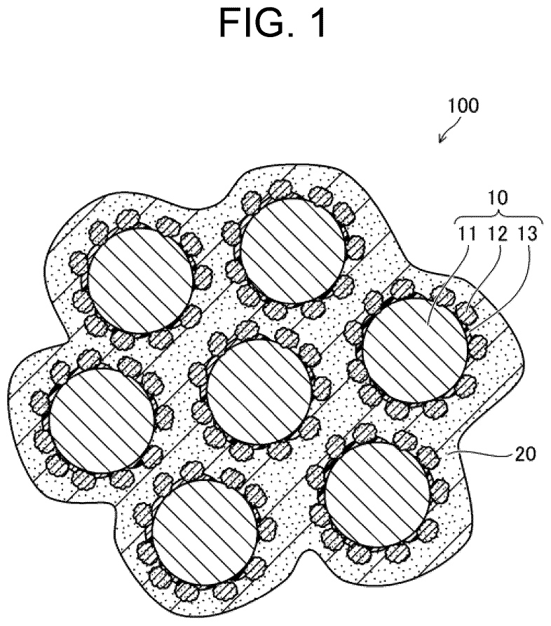

FIG. 1 is a cross-sectional view of an iron ion-releasing substance 100 according to the present disclosure. As illustrated in FIG. 1, the iron ion-releasing substance 100 according to the present disclosure includes a developer 10 and a carbon material 20. The iron ion-releasing substance 100 according to the present disclosure is a molded body obtained by pressing and molding the developer 10 and the carbon material 20. The iron ion-releasing substance 100 is the molded body, but not a sintered body. The iron ion-releasing substance 100 according to the present disclosure is a molded body obtained by pressing and molding without heating.

Hereinafter, the developer 10 and the carbon material 20 will be described.

As illustrated in FIG. 1, the carbon material 20 covers the developer 10. The carbon material 20 may cover the whole surface of the developer 10. Since the carbon material 20 is in contact with the developer 10, a local cell is produced to release iron ions.

The carbon material 20 is also used as a binder for pressing and molding the developer 10 to obtain a molded body. The usable carbon material 20 is, for example, coke, charcoal, coal powder, graphite, coal tar pitch, carbon black, acetylene black, activated carbon, a porous carbon material, or the like. The carbon materials may be used alone, or a mixture of two or more types thereof may be used. Although the shape and particle diameter of the carbon material are not limited, the carbon material preferably has a powder form, and preferably has a particle diameter smaller than that of a carrier in terms of increasing the contact point between the carbon material and a carrier core. In particular, the particle diameter is preferably 500 μm or less, more preferably 50 μm or less. This is because as the particle diameter is smaller, the surface area is larger, and the contact point between the carbon material and the carrier core is more.

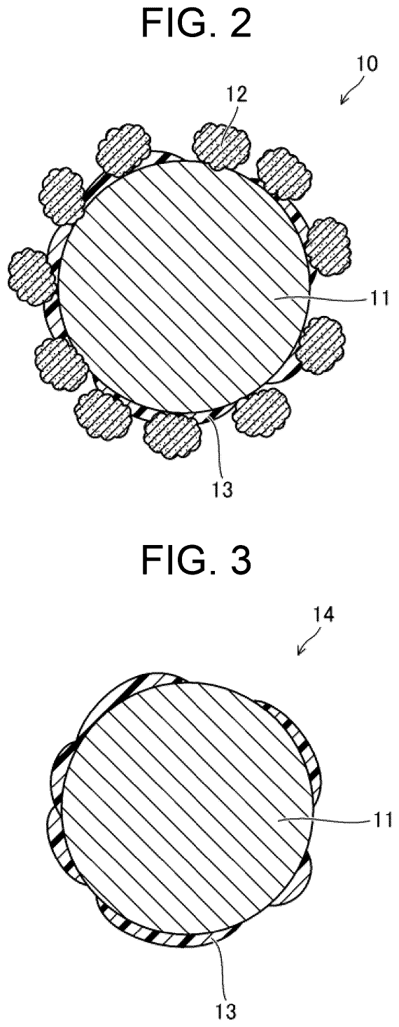

FIG. 2 is a cross-sectional view of the developer 10 in the iron ion-releasing substance 100 according to the present disclosure. As illustrated in FIG. 2, the developer 10 includes a carrier core 11 containing metal iron, and a toner 12 attached to part of a surface of the carrier core 11. The toner 12 also functions as the binder for the iron ion-releasing substance 100.

The developer 10 is used for printing with a printer or the like, and may be an unused or used developer.

Since the iron ion-releasing substance 100 includes the carrier core 11 containing metal iron, the carrier core 11 and the carbon material 20 come into contact with each other in water, and react with each other, to produce divalent iron ions.

The developer 10 has a small particle diameter of 100 μm or less and a larger surface area. Further, there are many contact points between iron contained in the carrier core 11 and carbon contained in the carbon material 20 and the toner 12. Therefore, the iron ion-releasing substance 100 including the developer 10 can sufficiently disperse iron ions in water and release a stable amount of iron ions for an extended period of time. Furthermore, the iron ion-releasing substance 100 according to the present disclosure does not require sintering, and thus an environmental load in manufacturing can also be reduced.

Hereinafter, the carrier core 11 and the toner 12 in the developer 10 will be described in detail.

The carrier core 11 contains metal iron. The metal iron is not iron oxide such as ferrite, and is discriminated from iron oxide. The shape of the carrier core 11 may be an irregular or spherical shape. As the carrier core 11, those having an average particle diameter of 10 μm or more and 150 μm or less, preferably 30 μm or more and 100 μm or less can be used. As iron particles, publicly known iron particles can be used. Examples thereof include reduced iron particles, atomized iron particles, and iron nitride particles. The reduced iron particles and iron nitride particles are irregular shape, and thus may be subjected to a spheronization treatment.

The toner 12 is attached to and connected with parts of surfaces of the carrier core 11 and a carrier coating agent 13. The concentration of the toner 12 contained in the developer 10 is preferably 3 to 10 wt %, more preferably 5 to 9 wt %. When this concentration is within this range, the toner 12 functions as the binder for the iron ion-releasing substance 100, and is less likely to collapse in water.

The carrier coating agent 13 contains carbon, preferably contains carbon black. The carbon black is contained preferably at 5 to 10 wt % in the carrier coating agent 13. In this case, electrons generated during the generation of iron ions can be stored also in carbon of the carrier coating agent 13 by the action of the coating agent as a conducting agent due to carbon or carbon black contained in the coating agent. Since the toner 12 also functions as the binder and the toner 12 and the carrier coating agent 13 contain carbon, electrons can pass through the whole of the iron ion-releasing substance 100, and electrons precipitated and collected during the addition of the iron ion-releasing substance to water can be released in the earth. Without means for storing electrons and releasing electrons outside the system of the iron ion-releasing substance 100, electrons remain in the iron ion-releasing substance 100. Therefore, iron ions can be released for a more extended period of time.

Since the carrier core 11 contains metal iron and the carbon material 20, the carrier coating agent 13, and the toner 12 contain carbon as described above, a cell reaction is locally caused due to a difference in electronegativity between iron and carbon (Fe: 1.8 and C: 2.5) that is generated by the addition to water, and iron electrons are transferred to carbon, to produce divalent iron ions. In other words, the iron ion-releasing substance according to the present disclosure includes the toner in addition to the carrier core containing metal iron, and thus can release a stable amount of iron ions for an extended period of time.

The toner 12 includes toner base particles and an external additive.

The toner base particles contain a binding resin, a colorant, and a release agent. In addition, the toner base particles may contain a charge control agent, a wax dispersant, a grinding aid, and the like, if necessary. The volume average particle diameter of the toner base particles is not particularly limited, and can be appropriately selected according to a purpose. The volume average particle diameter is preferably 4 to 8 μm. The particle diameter distribution of the toner base particles is not particularly limited, and can be appropriately selected according to a purpose. The toner base particles having a particle diameter of 3 μm or less preferably account for 40% by number or less. The circularity of the toner base particles is not particularly limited, can be appropriately selected according to a purpose, and is preferably 0.92 or more and 0.97 or less. The glass transition point (Tg) of the toner base particles is preferably 60° C. or lower.

As the binding resin, a resin commonly used in the technical field can be used. A plurality of types of resins may be used in combination. The glass transition point (Tg) of the binding resin is preferably 40° C. or higher and lower than 70° C.

As the colorant, a carbon-based coloring material can be used. Examples thereof include carbon black, acetylene black, activated carbon, graphite, and a porous carbon material. The amount of the colorant is preferably 5 to 10 parts by weight, more preferably 7 to 10 parts by weight, relative to 100 parts by weight of the resin.

As the release agent, a release agent commonly used in the technical field can be used. A plurality of types of release agents may be used in combination. The melting point of the release agent is preferably 70° C. or higher and lower than 150° C. The amount of the release agent mixed can be appropriately selected according to a purpose. The amount of the release agent mixed is preferably 0.5 to 5.0 parts by weight, more preferably 2.0 to 5.0 parts by weight, relative to 100 parts by weight of the resin.

As the charge control agent, a charge control agent commonly used in the technical field can be used. The amount of the charge control agent mixed can be appropriately selected according to a purpose. The amount of the charge control agent mixed is preferably 0.5 to 3 parts by weight relative to 100 parts by weight of the resin. The amount of the charge control agent mixed on a weight percent basis is preferably 0.5 to 2.0 wt %.

As the wax dispersant, a wax dispersant commonly used in the technical field can be used.

As the grinding aid, a grinding aid commonly used in the technical field can be used.

As the external additive, an external additive commonly used in the technical field can be used.

FIG. 3 is a cross-sectional view of a carrier 14 in the iron ion-releasing substance 100 according to the present disclosure. As illustrated in FIG. 3, the carrier 14 contains the carrier core 11 and the carrier coating agent 13 covering part of the carrier core 11.

As the particle diameter of the carrier 14 in the developer 10, D50 is 20 to 100 μm, and (D90-D10)/D50 is preferably 0.5 to 2.0, more preferably 0.8 to 1.3. The particle size distribution of the developer 10 is sharp and uniform. In this case, the number of contact point where a local cell is formed from metal iron of the carrier core 11 and carbon of the carbon material 20 and the toner 12 is increased, and the efficiency of iron ion release is increased. When mixing properties are improved, the carbon material 20 can be uniformly mixed. On the other hand, it is considered that when the particle diameter is large, the contact point between metal iron and carbon is decreased, and when the particle diameter is small, a bulk specific gravity is decreased, to deteriorate mixing properties with the carbon material 20, released iron produces a void in the iron ion-releasing substance 100, and the iron ion-releasing substance 100 is likely to collapse.

The ratio of the developer 10 to the carbon material 20 is preferably 3:7 to 9:1, preferably 7:3 to 9:1. In this case, the contact point between metal iron contained in the carrier core 11 of the developer 10 and the carbon material 20 can be increased, and the efficiency of iron ion release is increased.

Preferably, the developer 10 further includes the carrier coating agent 13 coating parts of the carrier core 11 and the toner 12. At a location where water is in contact with metal iron, corrosion of the iron ion-releasing substance 100 can be prevented by covering part of the location with the carrier coating agent 13. Although the carrier core 11 is decreased in size by iron ion release, the shape of the iron ion-releasing substance is maintained by the carrier coating agent 13, and the iron ion-releasing substance is less likely to collapse in water for an extended period of time.

The carrier coating agent 13 contains carbon, preferably contains carbon black. Electrons generated during the generation of iron ions can be stored also in carbon of the carrier coating agent 13 by the action of the carrier coating agent 13 as a conducting agent due to carbon or carbon black contained in the carrier coating agent 13. When electrons remain in the proximity of the contact point between iron and carbon, iron ion release may be suppressed. Thus, a stable amount of iron ions can be released for a more extended period of time.

The proportion of the carrier coating agent 13 contained in the carrier 14 is preferably 0.5 to 5.0 wt %, more preferably 0.5 to 3.0 wt %. In this case, electrons can be moderately stored in carbon of the carrier coating agent 13, and a stable amount of iron ions can be released for a more extended period of time.

The coverage ratio of the carrier core 11 with the carrier coating agent 13 is preferably 30 to 90%, more preferably 60 to 80%. In this case, the carrier coating agent 13 is peeled to some extent from the carrier core 11, metal iron of the carrier core 11 is exposed, and contact properties between the carbon material 20 and the carrier core 11 are improved, and the efficiency of iron ion release is increased. When the developer 10 including the carrier coating agent 13 is used for printing with a printer or the like, the coverage ratio of the carrier core 11 with the carrier coating agent 13 is decreased.

Although the developer 10 that may be an unused or used developer is described above, the used developer that decreases the coverage ratio (coverage ratio of 90% or less) is preferred. In this case, an environmental load is reduced by reusing for the iron ion-releasing substance the developer 10 that has been used for a printer or the like.

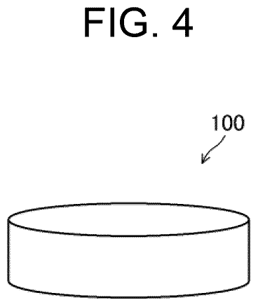

FIG. 4 is a view of the iron ion-releasing substance according to the present disclosure that is formed into a pellet shape. The iron ion-releasing substance 100 according to the present disclosure may be a pellet-shaped molded body as illustrated in FIG. 4.

An action of the iron ion-releasing substance 100 according to the present disclosure will be described.

When the iron ion-releasing substance 100 according to the present disclosure is soaked in water, iron ions are released.

The iron ions react with an ambient substance. For example, the iron ions react with hydrogen sulfide (H₂S) that causes malodor from sludge or the like, and phosphoric acid from a detergent, agricultural chemical, or fertilizer that causes eutrophication. Thus, hydrogen sulfide (H₂S) that causes malodor and phosphoric acid that causes eutrophication can be removed from water. As a result, iron sulfide and iron phosphate are produced and precipitated.

Thus, the iron ion-releasing substance 100 according to the present disclosure can prevent eutrophication that causes water-bloom and red tide and malodor from sludge or the like, and clean and improve water quality. Furthermore, by absorbing iron by plants P in water, activating photosynthesis, and increasing the oxygen concentration in water, the environment can be improved.

### EXAMPLES

Hereinafter, the iron ion-releasing substance according to the present disclosure will be described specifically by Examples and Comparative Examples. However, the present disclosure is not limited to Examples described herein.

### Example 1

### Production of Carrier Core

A silicone resin (KR-255 manufactured by Shin-Etsu Chemical Co., Ltd.) and carbon black (Ketjen black EC manufactured by Lion Specialty Chemicals Co., Ltd.) were added such that the concentration of carbon black was 5.0 wt %, and dispersed in toluene, to obtain a dispersion solution. The resultant dispersion solution was applied to iron particles having a particle diameter of 60 μm with a fluidized bed coating apparatus, and heated at 250° C. for 2 hours, to cure the applied coating resin. Thus, a carrier core partially covered with a carrier coating agent was obtained.

### Production of Toner

Subsequently, a binding resin (89 mass % of polyester resin), a colorant (8 mass % of carbon black (product name: MA-77 manufactured by Mitsubishi Chemical Corporation)), a release agent (2 mass % of paraffinic wax (melting point: 90° C., product name: Fischer-Tropsch wax FNP0090 manufactured by Nippon Seiro Co., Ltd.)), and a charge control agent (1 mass % of potassium salt (potassium bis[benzilate(2-)-κ(2)O,O] borate(1−), solubility in water: 4.382 g/L (20° C.), product name: ion conductive material LR-147 manufactured by Japan Carlit Co., Ltd.)) as raw materials were pre-mixed at a rotational speed of 1,500 rpm for 5 minutes with a high-performance flow type mixer (Henschel mixer, total capacity: 20 L, manufactured by Mitsui Mining Co., Ltd. (current name Nippon Coke & Engineering Co., Ltd.), model: FM20C).

The resultant mixture was melt-kneaded under conditions of a cylinder setting temperature of 100° C., a barrel rotational speed of 250 rpm, and a raw material supply speed of 10 kg/h with a twin-screw extruder (manufactured by Ikegai Co., Ltd., model: PCM-30), to obtain a melt-kneaded product.

The resultant melt-kneaded product was cooled and solidified with a cooling belt, and a solidified product was pulverized with a fluidized bed opposed jet mill (manufactured by Hosokawa Micron Corporation, model: counter jet mill AFG), and classified (particle size adjustment) with a rotary (centrifugal airflow) classifier (manufactured by Hosokawa Micron Corporation, model: TSP separator), to obtain toner particles (toner core) having a volume average particle diameter of 5.0 μm to 7.0 μm.

To 1,000 g of the resultant toner particles, 10 g of commercially available silica fine particles (product name: R976s manufactured by Nippon Aerosil Co., Ltd.) and 3 g of silica-doped strontium titanate (fine powder in which the surface of a composition containing strontium titanate and silica was hydrophobized with a silane compound, average primary particle diameter: 20 μm) as external additives were added, and the mixture was mixed at a rotational speed of 3,500 rpm for 3 μminutes with a high-performance flow type mixer (Henschel mixer, total capacity: 20 L, manufactured by Mitsui Mining Co., Ltd. (current name Nippon Coke & Engineering Co., Ltd.), model: FM20C), to obtain 1 kg of toner.

### Production of Developer

The toner and the carrier core obtained by the production methods described above were weighed such that the toner concentration was 7.0% (toner/carrier=1/13.3), and stirred and mixed for 20 minutes with a V type mixer (manufactured by Tokuju Corporation, model: V-5), to obtain a two-component developer.

A development unit of a commercially available copying machine was filled with the two-component developer, an original having a printing area ratio of 5% was printed on 100,000 sheets of A4-size record paper, the two-component developer was then collected from a development tank, and the coverage ratio of the carrier core with the carrier coating agent was measured. The coverage ratio of the carrier core with the carrier coating agent was 70%.

As the average particle diameter of the developer, D50 was 60 μm, (D90-D10)/D50 was 1.3, the toner concentration was 7 wt %, and the concentration of carbon black in the toner was 8 wt %.

### Method for Producing Iron Ion-Releasing Substance

In a method for producing an iron ion-releasing substance, the two-component developer after the printing and a carbon material (carbon black (product name: MA-77 manufactured by Mitsubishi Chemical Corporation)) was weighed at a ratio of 3:1 (7.5 g of two-component developer and 2.5 g of carbon material), placed in a wide mouth bottle (I-Boy 50-mL PP wide mouth bottle manufactured by AS ONE Corporation was used at that time), and mixed with a double-end drive polyethylene bottle rotating machine (manufactured by Tanaka Tec Corporation, model: RPB-3S). The mixed sample was molded into a cylindrical pellet shape having a diameter of 25 (ultra-hard dice with a diameter of 25, 30 MPa, 1 minute) with 50-kN table press TB-50H (manufactured by NPa System Co., Ltd.).

Thus, the iron ion-releasing substance in Example 1 was obtained.

### Example 2

In Example 2, an iron ion-releasing substance according to Example was obtained under the same condition as that in Example 1 except that the average particle diameter D50 of the developer was 17 μm.

### Example 3

In Example 3, an iron ion-releasing substance according to Example was obtained under the same condition as that in Example 1 except that the average particle diameter D50 of the developer was 20 μm.

### Example 4

In Example 4, an iron ion-releasing substance according to Example was obtained under the same condition as that in Example 1 except that the average particle diameter D50 of the developer was 100 μm.

### Example 5

In Example 5, an iron ion-releasing substance according to Example was obtained under the same condition as that in Example 1 except that the average particle diameter D50 of the developer was 105 μm.

### Example 6

In Example 6, an iron ion-releasing substance according to Example was obtained under the same condition as that in Example 1 except that the average particle diameter D50 of the developer was 55 μm and (D90-D10)/D50 was 0.4.

### Example 7

In Example 7, an iron ion-releasing substance according to Example was obtained under the same condition as that in Example 1 except that the average particle diameter D50 of the developer was 56 μm and (D90-D10)/D50 was 0.5.

### Example 8

In Example 8, an iron ion-releasing substance according to Example was obtained under the same condition as that in Example 1 except that the average particle diameter D50 of the developer was 62 μm and (D90-D10)/D50 was 2.0.

### Example 9

In Example 9, an iron ion-releasing substance according to Example was obtained under the same condition as that in Example 1 except that the average particle diameter D50 of the developer was 64 μm and (D90-D10)/D50 was 2.1.

### Example 10

In Example 10, an iron ion-releasing substance according to Example was obtained under the same condition as that in Example 1 except that the average particle diameter D50 of the developer was 59 μm, (D90-D10)/D50 was 1.4, and the carrier coating agent was not added.

### Example 11

In Example 11, an iron ion-releasing substance according to Example was obtained under the same condition as that in Example 1 except that the average particle diameter D50 of the developer was 58 μm and the coverage ratio with the carrier coating agent was 28%.

### Example 12

In Example 12, an iron ion-releasing substance according to Example was obtained under the same condition as that in Example 1 except that the average particle diameter D50 of the developer was 58 μm and the coverage ratio with the carrier coating agent was 30%.

### Example 13

In Example 13, an iron ion-releasing substance according to Example was obtained under the same condition as that in Example 1 except that the coverage ratio with the carrier coating agent was 90%.

### Example 14

In Example 14, an iron ion-releasing substance according to Example was obtained under the same condition as that in Example 1 except that the coverage ratio with the carrier coating agent was 93%.

### Example 15

In Example 15, an iron ion-releasing substance according to Example was obtained under the same condition as that in Example 1 except that carbon black was not used in the carrier coating agent.

### Example 16

In Example 16, an iron ion-releasing substance according to Example was obtained under the same condition as that in Example 1 except that the toner concentration in the developer was 2.8 wt %.

### Example 17

In Example 17, an iron ion-releasing substance according to Example was obtained under the same condition as that in Example 1 except that the toner concentration in the developer was 3.0 wt %.

### Example 18

In Example 18, an iron ion-releasing substance according to Example was obtained under the same condition as that in Example 1 except that the toner concentration in the developer was 10.0 wt %.

### Example 19

In Example 19, an iron ion-releasing substance according to Example was obtained under the same condition as that in Example 1 except that the toner concentration in the developer was 10.5 wt %.

### Example 20

In Example 20, an iron ion-releasing substance according to Example was obtained under the same condition as that in Example 1 except that the concentration of carbon black in the toner was 4.8 wt %.

### Example 21

In Example 21, an iron ion-releasing substance according to Example was obtained under the same condition as that in Example 1 except that the concentration of carbon black in the toner was 5.0 wt %.

### Example 22

In Example 22, an iron ion-releasing substance according to Example was obtained under the same condition as that in Example 1 except that the concentration of carbon black in the toner was 10.0 wt %.

### Example 23

In Example 23, an iron ion-releasing substance according to Example was obtained under the same condition as that in Example 1 except that the concentration of carbon black in the toner was 10.2 wt %.

### Example 24

In Example 24, an iron ion-releasing substance according to Example was obtained under the same condition as that in Example 1 except that the ratio of the developer to the carbon material was 1.0:4.0.

### Example 25

In Example 25, an iron ion-releasing substance according to Example was obtained under the same condition as that in Example 1 except that the ratio of the developer to the carbon material was 3.0:7.0.

### Example 26

In Example 26, an iron ion-releasing substance according to Example was obtained under the same condition as that in Example 1 except that the ratio of the developer to the carbon material was 9.0:1.0.

### Example 27

In Example 27, an iron ion-releasing substance according to Example was obtained under the same condition as that in Example 1 except that the ratio of the developer to the carbon material was 9.5:0.5.

### Comparative Example 1

In Comparative Example 1, an iron ion-releasing substance according to Comparative Example was obtained using ferrite that was a sintered body obtained by heating, but not a molded body obtained by pressing and molding.

### Comparative Example 2

In Comparative Example 2, an iron ion-releasing substance according to Comparative Example (that was not a molded body) was obtained only by producing a developer in the same manner as in Example 1 and mixing the developer and the carbon material without pressing or molding.

### Comparative Example 3

In Comparative Example 3, an iron ion-releasing substance according to Comparative Example was obtained under the same condition as that in Example 1 except that the carbon material was not added.

For a particle diameter and (D90-D10)/D50, the average particle diameters D50, D90, and D10 were measured using a microtrac particle size analyzer (manufactured by Nikkiso Co., Ltd.).

The amount of the carrier coating agent was confirmed with a calorimeter (TGA) by the presence or absence of mass decrease when the temperature was increased from room temperature to 800° C. in a nitrogen atmosphere at a temperature increasing rate of 10° C./min. The separation from the toner in the developer was confirmed with an apparatus (manufactured by TREK JAPAN, model: 210HS-2A). 0.2 g of the developer was placed on a stand, and covered with a stainless steel mesh (#795). Subsequently, a suction nozzle was brought above the mesh, and the toner in the developer was sucked and separated.

The coverage ratio of the carrier core with the carrier coating agent was calculated by the following process. The surface of the developer including the carrier coating agent was observed with a scanning electron microscope (SEM) using an electron beam with an accelerating voltage of 2.0 kV without vapor depositing with a conducting agent such as gold. The carrier core (metal iron) was observed to be white. Thus, the proportion of the area of a region other than the carrier core relative to the total area of the developer was calculated. This operation was performed for 100 carrier particles, and the average value of the obtained values was determined as the coverage ratio.

The presence or absence of carbon black in the carrier coating agent was confirmed with a calorimeter (TGA). The sample was heated from 40° C. to 600° C. at 20° C./min in a nitrogen atmosphere, and then kept for 5 minutes. At that time, an organic substance other than carbon black (CB) was decomposed. The sample was then cooled to 400° C. at 20° C./min, the nitrogen atmosphere was changed to an air atmosphere, the atmosphere was kept for 5 minutes, and the temperature was increased to 800° C. at 20° C./min, and kept for 30 minutes. From a weight reduction ratio confirmed after change from the nitrogen atmosphere to the air atmosphere, the contained carbon material (carbon black) is seen.

The toner concentration in the developer was confirmed with an apparatus (manufactured by TREK JAPAN, model: 210HS-2A). 0.2 g of the developer was placed on a stand, and covered with a stainless steel mesh (#795). Subsequently, a suction nozzle was brought above the mesh, and the toner in the developer was sucked. Next, the weight of the developer left on the stand was measured, and the toner concentration was determined.

The carbon black concentration in the toner was determined and calculated with TGA using the toner sucked during the determination of the toner concentration in the developer. The sample was heated from 40° C. to 600° C. at 20° C./min in a nitrogen atmosphere, and then kept for 5 minutes. At that time, an organic substance other than carbon black (CB) was decomposed. The sample was then cooled to 400° C. at 20° C./min, the nitrogen atmosphere was changed to an air atmosphere, the atmosphere was kept for 5 minutes, and the temperature was increased to 800° C. at 20° C./min, and kept for 30 minutes. The weight reduction ratio after change from the nitrogen atmosphere to the air atmosphere was considered as a carbon black amount.

The particle diameter of the developer and the composition of the iron ion-releasing substance are shown in Tables below.

TABLE 1A

| | | | | | Coverage | Presence | | | |
|---|---|---|---|---|---|---|---|---|---|
| | Presence | | | | ratio | or absence | | | |
| | or | | | Presence or | with | of carbon | | | |
| | absence | Average | | absence of | carrier | black in | | CB | |
| | of metal | particle | | carrier | coating | carrier | Toner | amount | Developer: |
| | iron in | diameter | | coating | agent | coating | concentration | in toner | carbon |
| | developer | D50 (μm) | (D90-D10)/D50 | agent | % | agent | wt % | wt % | material |
| Example 1 | Present | 60 | 1.3 | Present | 70 | Present | 7 | 8 | 3.0:1.0 |
| Example 2 | Present | 17 | 1.3 | Present | 70 | Present | 7 | 8 | 3.0:1.0 |
| Example 3 | Present | 20 | 1.3 | Present | 70 | Present | 7 | 8 | 3.0:1.0 |
| Example 4 | Present | 100 | 1.3 | Present | 70 | Present | 7 | 8 | 3.0:1.0 |
| Example 5 | Present | 105 | 1.3 | Present | 70 | Present | 7 | 8 | 3.0:1.0 |
| Example 6 | Present | 55 | 0.4 | Present | 70 | Present | 7 | 8 | 3.0:1.0 |
| Example 7 | Present | 56 | 0.5 | Present | 70 | Present | 7 | 8 | 3.0:1.0 |
| Example 8 | Present | 62 | 2.0 | Present | 70 | Present | 7 | 8 | 3.0:1.0 |
| Example 9 | Present | 64 | 2.1 | Present | 70 | Present | 7 | 8 | 3.0:1.0 |
| Example 10 | Present | 59 | 1.4 | Absent | 70 | Present | 7 | 8 | 3.0:1.0 |
| Example 11 | Present | 58 | 1.3 | Present | 28 | Present | 7 | 8 | 3.0:1.0 |
| Example 12 | Present | 59 | 1.3 | Present | 30 | Present | 7 | 8 | 3.0:1.0 |
| Example 13 | Present | 60 | 1.3 | Present | 90 | Present | 7 | 8 | 3.0:1.0 |
| Example 14 | Present | 60 | 1.3 | Present | 93 | Present | 7 | 8 | 3.0:1.0 |
| Example 15 | Present | 60 | 1.3 | Present | 70 | Absent | 7 | 8 | 3.0:1.0 |
| Example 16 | Present | 60 | 1.3 | Present | 70 | Present | 2.8 | 8 | 3.0:1.0 |
| Example 17 | Present | 60 | 1.3 | Present | 70 | Present | 3.0 | 8 | 3.0:1.0 |
| Example 18 | Present | 60 | 1.3 | Present | 70 | Present | 10.0 | 8 | 3.0:1.0 |
| Example 19 | Present | 60 | 1.3 | Present | 70 | Present | 10.5 | 8 | 3.0:1.0 |
| Example 20 | Present | 60 | 1.3 | Present | 70 | Present | 7 | 4.8 | 3.0:1.0 |
| Example 21 | Present | 60 | 1.3 | Present | 70 | Present | 7 | 5.0 | 3.0:1.0 |
| Example 22 | Present | 60 | 1.3 | Present | 70 | Present | 7 | 10.0 | 3.0:1.0 |
| Example 23 | Present | 60 | 1.3 | Present | 70 | Present | 7 | 10.2 | 3.0:1.0 |

TABLE 1B

| | | | | | Coverage | Presence | | | |
|---|---|---|---|---|---|---|---|---|---|
| | Presence | | | | ratio | or absence | | | |
| | or | | | Presence or | with | of carbon | | | |
| | absence | Average | | absence of | carrier | black in | | CB | |
| | of metal | particle | | carrier | coating | carrier | Toner | amount | Developer: |
| | iron in | diameter | | coating | agent | coating | concentration | in toner | carbon |
| | developer | D50 (μm) | (D90-D10)/D50 | agent | % | agent | wt % | wt % | material |
| Example 24 | Present | 60 | 1.3 | Present | 70 | Present | 7 | 8 | 1.0:4.0 |
| Example 25 | Present | 60 | 1.3 | Present | 70 | Present | 7 | 8 | 3.0:7.0 |
| Example 26 | Present | 60 | 1.3 | Present | 70 | Present | 7 | 8 | 9.0:1.0 |
| Example 27 | Present | 60 | 1.3 | Present | 70 | Present | 7 | 8 | 9.5:0.5 |
| Comparative | Absent | 50 | 1.1 | Present | 70 | Present | 7 | 8 | 3.0:1.0 |
| Example 1 | (Ferrite) | | | | | | | | |
| Comparative | Present | 60 | 1.3 | Present | 70 | Present | 7 | 8 | 3.0:1.0 |
| Example 2 | | | | | | | | | |
| Comparative | Present | 60 | 1.3 | Present | 70 | Present | 7 | 8 | 10:0 |
| Example 3 | | | | | | | | | |

The iron ion-releasing substance according to each of Examples and Comparative Examples was immersed in water, and a Fe²⁺ concentration in water was measured after 3 days and 10 days. The determination of Fe²⁺ concentration is as follows. Distilled water in an amount 20 times the weight of the produced iron ion-releasing substance was placed in a sample bottle made of glass (when the weight of the sample was 5 g, 100 g of distilled water was used), and allowed to stand for 3 days and 10 days. From the supernatant liquid of the water, the concentration of divalent iron ions was determined using PACKTEST (KYORITSU CHEMICAL-CHECK Lab., Corp.).

The appearance of a molded body after immersion of the iron ion-releasing substance according to each of Examples and Comparative Examples in water was observed immediately after immersion and after 10 days. The observation evaluation of the appearance is as follows.
Very excellent: The shape during molding is kept (very excellent)
Excellent: The molded body partially collapses (excellent)
Good: The molded body collapses, but barely remains in shape (good)
Poor: The shape during molding is not kept (is almost powdered) (poor)

The evaluation results are shown in Table below.

TABLE 2

| | Fe²⁺ release | | | |
|---|---|---|---|---|
| | amount (ppm) | | Appearance of molded body | |
| | After | After | After | |
| | 3 days | 10 days | immersion | After 10 days |
| Example 1 | 5 | >10 | Very excellent | Very excellent |
| Example 2 | 3 | 5 | Good | Good |
| Example 3 | 5 | 7.5 | Excellent | Excellent |
| Example 4 | 5 | 7.5 | Excellent | Excellent |
| Example 5 | 1 | 3 | Good | Good |
| Example 6 | 3 | 5 | Good | Good |
| Example 7 | 5 | 7.5 | Excellent | Good |
| Example 8 | 5 | 7.5 | Excellent | Good |
| Example 9 | 2 | 3 | Good | Good |
| Example 10 | 5 | 10 | Good | Good |
| Example 11 | 3 | 5 | Very excellent | Good |
| Example 12 | 5 | 7.5 | Very excellent | Good |
| Example 13 | 5 | 7.5 | Very excellent | Very excellent |
| Example 14 | 0.5 | 2 | Very excellent | Very excellent |
| Example 15 | 0.5 | 2 | Very excellent | Very excellent |
| Example 16 | 3 | 5 | Excellent | Good |
| Example 17 | 5 | 10 | Excellent | Good |
| Example 18 | 5 | 7.5 | Very excellent | Very excellent |
| Example 19 | 1 | 2 | Very excellent | Very excellent |
| Example 20 | 1 | 3 | Very excellent | Very excellent |
| Example 21 | 5 | 10 | Very excellent | Very excellent |
| Example 22 | 5 | >10 | Excellent | Excellent |
| Example 23 | 5 | 10 | Excellent | Good |
| Example 24 | 0.1 | 0.5 | Very excellent | Very excellent |
| Example 25 | 5 | 7.5 | Very excellent | Very excellent |
| Example 26 | 5 | >10 | Excellent | Excellent |
| Example 27 | 3 | 5 | Good | Good |
| Comparative | <0.05 | <0.05 | Very excellent | Very excellent |
| Example 1 | | | | |
| Comparative | <0.05 | <0.05 | Poor | Poor |
| Example 2 | | | | |
| Comparative | <0.05 | <0.05 | Excellent | Good |
| Example 3 | | | | |

In all Examples, the Fe²⁺ concentrations after 3 days and after 10 days were 0.1 ppm or more, and iron ions were released and sufficiently dispersed in water. In particular, the iron ion-releasing substance having a low coverage ratio of the carrier core with the carrier coating agent tends to release a larger amount of Fe²⁺ and showed excellent results. Further, the iron ion-releasing substance having a small particle diameter, the iron ion-releasing substance having a low toner concentration, and the iron ion-releasing substance having a high ratio of the developer tend to release a larger amount of Fe²⁺ and showed excellent results.

In all Examples, the shape during molding was kept immediately after immersion and after 10 days, and excellent results of appearance were shown. In particular, the iron ion-releasing substance having a high coverage ratio of the carrier core with the carrier coating agent keeps the shape during molding, and showed excellent results.

Further, the iron ion-releasing substance having a high toner concentration, the iron ion-releasing substance having a low carbon black concentration, and the iron ion-releasing substance having a high ratio of the carbon material also showed excellent results.

On the other hand, in Comparative Example 1 using ferrite, Comparative Example 2 in which molding was not performed, and Comparative Example 3 in which the carbon material was not added, the amount of Fe²⁺ released was highly small, which was a poor result. In Comparative Examples except Comparative Example 1, the results of appearance after immersion were poor.

As described above, the iron ion-releasing substance according to the present disclosure can sufficiently disperse iron ions in water and release a stable amount of iron ions for an extended period of time.

Although the embodiments and Examples of the present disclosure have been described above in detail, those skilled in the art will easily understand that a number of modifications can be made within a range not substantially departing from the novelties and effects of the present disclosure. Therefore, all such modifications are included in the scope of the present disclosure.

For example, a term described in the specification or drawings at least once together with a term having a broader meaning or the same meaning may be replaced with the different term anywhere in the specification or drawings. The configuration and operation of the iron ion-releasing substance are also not limited to those described in the embodiments and Examples of the present disclosure, and various modifications can be made thereto. While there have been described what are at present considered to be certain embodiments of the invention, it will be understood that various modifications may be made thereto, and it is intended that the appended claims cover all such modifications as fall within the true spirit and scope of the invention.

What is claimed is:

1. An iron ion-releasing substance comprising:
a developer including a carrier core containing metal iron, and a toner attached to part of a surface of the carrier core; and
a carbon material covering the developer,
wherein the iron ion-releasing substance is a molded body obtained by pressing and molding the developer and the carbon material.

2. The iron ion-releasing substance according to claim 1, wherein the developer further includes a carrier coating agent covering part of the carrier core and the toner.

3. The iron ion-releasing substance according to claim 1, wherein the developer further includes a carrier containing the carrier core and a carrier coating agent covering part of the carrier core, and
wherein the carrier has as a particle diameter D50 of 20 to 100 μm and (D90-D10)/D50 of 0.5 to 2.0.

4. The iron ion-releasing substance according to claim 1, wherein the toner is contained at 3 to 10 wt % in the developer.

5. The iron ion-releasing substance according to claim 1, wherein a ratio of the developer to the carbon material is 3:7 to 9:1.

6. The iron ion-releasing substance according to claim 2, wherein the carrier coating agent contains carbon black.

7. The iron ion-releasing substance according to claim 1, wherein the toner contains carbon black, and
wherein the carbon black contained in the toner is contained at 5 to 10 wt % in the developer.

8. The iron ion-releasing substance according to claim 2, wherein a coverage ratio of the carrier core with the carrier coating agent is 30 to 90%.
